(19) United States
(12) Patent Application Publication
(10) Pub. No.: US 2017/0246609 A1
(43) Pub. Date: Aug. 31, 2017

(54) NANO-PARTICULATE CAPSULES AND EMULSIONS THEREOF INCLUDING FRAGRANCE BY EMULSION POLYMERIZATION

(71) Applicant: ASIAN PAINTS LTD., Mumbai (IN)

(72) Inventors: Shiva Kumar Ega, Navi Mumbai (IN); Swapan Kumar Ghosh, Navi Mumbai (IN); B.P. Mallik, Navi Mumbai (IN)

(73) Assignee: ASIAN PAINTS LTD., Mumbai (IN)

(21) Appl. No.: 15/511,064

(22) PCT Filed: Dec. 19, 2014
(86) PCT No.: PCT/IN2014/000788

§ 371 Date: Mar. 14, 2017

(30) Foreign Application Priority Data
Sep. 15, 2014 (IN) 2935/MUM2014

(51) Int. Cl. B01J 13/18; C11B 9/00; C09D 7/12

(52) U.S. Cl. CPC B01J 13/185; C09D 7/1291; C11B 9/0003

(57) ABSTRACT

A nano-particulate composition comprising nano-particulate capsule comprising at least one or more of hydrophobic core material and a polymeric shell comprising homo-polymer or copolymers of at least one ethylenically unsaturated monomers or mixture thereof and having particle size distribution with an average article size in the range of 50 to 1000 nm is provided together with a controlled release delivery system comprising fragrance release delivery system involving said nano-particulate capsule water based emulsion and a process of manufacture thereof. Said delivery system provided is able to protect and release the fragrance in a controlled manner over a period of time. The controlled release fragrance delivery system of the present invention finds advantageous end use and application in fragranced consumer products formulations including water based coating/paint formulations and industrial formulations for use in industries including textile, cosmetics, soaps and detergents, leather industries.

### TECHNICAL FIELD

The present invention relates to nano-particulate compositions comprising nano-particulate capsule comprising at least one or more of hydrophobic core material and a polymeric shell comprising homo-polymer or copolymers of at least one ethylenically unsaturated monomers or mixture thereof and having particle size distribution with an average article size in the range of 50 to 1000 nm, and more particularly, relates to a controlled release delivery system comprising fragrance release delivery system involving said nano-particulate capsule water based emulsion and a process of manufacture thereof. Said delivery system is able to protect and release the fragrance in a controlled manner over a period of time. The controlled release fragrance delivery system of the present invention finds advantageous end use and application in fragranced consumer products formulations including water based coating/ paint formulations and industrial formulations for use in industries including textile, cosmetics, soaps and detergents, leather industries.

### BACKGROUND OF THE INVENTION

A principal strategy currently employed in imparting odours to consumer products is the admixing of the fragrance directly into the product. There are, however, several drawbacks to this strategy. The fragrance material can be too volatile, resulting in fragrance loss during manufacturing, storage and use. Many fragrance materials are also unstable over time. This again results in loss of fragrance during storage.

In many consumer products it is desirable for the fragrance to be released slowly over time. Since the most volatile fragrances, or top notes are responsible for the fresh feeling consumers experience, it is desirable that volatile fragrances are slowly released. Such slow release is commonly referred to as sustained release.

Encapsulation is a means to improve the stability of volatile and labile ingredients such as fragrances or flavours, by protecting them from all kinds of possible aggressions or degradation processes such as oxidation. Moreover, encapsulation is also a means to provide release of an active ingredient, which is spread out over a more or less extended period of time, instead of being instantaneous. In other words, encapsulation systems allow to slow the release of active ingredients, and therefore they may be suitable for an utilisation in applications wherein a controlled release is required. Finally, an encapsulated system can also constitute a means to improve the substantivity of molecules on a substrate, by providing a system capable of chemical or physical bonding with a particular surface or substrate.

Various methods for making capsules have been proposed in the literature. Many of the proposals involve forming the polymeric particles and then absorbing the active ingredient into the particles. For instance in JP 58-121212A particles of cross-linked sodium polyacrylate are formed and an aqueous emulsion of an active ingredient is then absorbed into the particles. In U.S. Pat. No. 4,269,959 cross-linked polymethyl methacrylate beads are formed and active ingredient is absorbed into the beads. In U.S. Pat. No. 4,303,642 an insecticide is absorbed into polymers formed from styrene or certain acrylates.

WO 98/28396 discloses latex having particle sizes larger than 10 microns which are produced by suspension polymerization of vinyl monomers. A fragrance is incorporated by mixing it with the monomers prior to polymerization or post-addition of the fragrance to the latex. The latex microparticles are surrounded by a polyhydroxy hydrocolloid layer which is claimed to enhance deposition of the fragrance on substrates.

EP 0617051 discloses polymeric compositions obtained by emulsion polymerization of unsaturated momomers, namely alkyl (meth) acrylates, in the presence of a fragrance. The particles are formed by oil-in-water emulsion polymerization of the water-insoluble monomer in which the active, ingredient, such as an agricultural semiochemical, is dissolved. WO 01/79303 discloses polymeric nano-particles including olfactive components obtainable by a semicontinuous polymerization. Styrene and acrylic acid derivatives as monomer components in the presence or absence of a cross-linking agent are exemplified.

A problem with these absorption methods is that it is difficult to obtain a satisfactory combination of absorption and controlled release. If absorption is easy then release tends to be too fast. If absorption is difficult then release may be non-existent or, if absorption is only at the surface, may be of short duration.

It is also known to incorporate the active ingredient during the formation of the particles. For instance in EP 67533A a film-forming polyacrylate, volatile solvent and particles of the active ingredient are sprayed, to form encapsulated polymer particles containing the active ingredient. In U.S. Pat. No. 3,400,093 a solid active ingredient (an insecticide) is stirred into an emulsion of monomer (for instance methyl methacrylate, styrene or certain blends such as methyl methacrylate-ethyl acrylate) and the mixture is then subjected to oil-in-water emulsion polymerization to form polymer particles containing the solid insecticide. This product is for use as a floor polish.

Micro-encapsulation and inclusion complexes with specific materials such as cyclodextrins have been used in the prior art patents WO 2008/104954 and U.S. 2004, 023,4479 to decrease volatility, improve stability and provide slow-release properties of perfuming ingredients. However, when contacted with an aqueous medium, cyclodextrin based systems release the fragrance immediately, which limits their use as controlled release systems, in particular in applications involving an aqueous medium, such as in water based coatings or paints.

It is known to encapsulate hydrophobic liquids by dispersing the hydrophobic liquid into an aqueous medium containing melamine formaldehyde pre-condensate and then reducing the pH resulting in an impervious aminoplast resin shell wall surrounding the hydrophobic liquid. Variations of this type of process are described in U.S. Pat. Nos. 7,238,655, 4,233,178, 4,409,156, 4,406,816 and 4,100,103.

However, although capsules based on melamine formaldehyde resins are both impervious and durable, they tend to suffer the disadvantage .that they are less impermeable at elevated temperatures. In addition, there is also a risk that formaldehyde is evolved.

WO 2005/002719 describes a method for preparing uniformly sized and shaped microcapsules using a mini emulsion polymerization. The method employs forming a mini emulsion by mixing a monomer, an emulsifer, an ultrahydrophobe, a low viscosity hydrophobic material, and deionised water. EP 1135429 and WO 2006/027664 reports a process for carrying out polyaddition reactions in miniemulsion containing pre-polymers and optionally traces of highly hydrophobic compounds or solid particles.

Miniemulsions are produced by the combination of high shear device to breakup the emulsion into submicron monomer droplets with a water-insoluble, monomer-soluble component to retard monomer diffusion from the submi-micron monomer droplets. For laboratory investigations of miniemulsions, a variety of high-shear devices have been used, although sonication has been the most popular. Sonication, however, may not be very practical for the large-scale production of commercial miniemulsion polymers.

It is therefore apparent form the prevailing state of the art that while several methods are employed for imparting odours to consumer products the methods suffer from serious drawbacks such as instability of the fragrance materials, its volatility, loss of fragrance during manufacture and storage, released too slowly or released too fast such that even encapsulation methods wherein the fragrances are adsorbed on the particles are also susceptible to difficulties in a satisfactory combination of adsorption and controlled release. Further micro-encapsulation and inclusion complexes involving encapsulating materials such as cyclodextrin and melamine formaldehyde pre-condensates either release the fragrance immediately or provide reduced permeability to the fragrance respectively.

Therefore it is a longfelt need in the, art to explore for new systems that would circumvent the cited prior art problems favouring achievement of fragrance release delivery system that would be able to protect and release the fragrance in a controlled manner over a period of time for its effective end use and application in various fragrance based consumer products.

### OBJECTS OF THE INVENTION

It is thus a primary object of the present invention to provide for nano-particulate compositions comprising nano-particulate capsule comprising at least one or more of hydrophobic core material and a polymeric shell that would favour effective sustained release of said hydrophobic core material over time. A novel process for producing nano-capsule or particles with core shell morphology for water based coatings and paints and which no longer have the disadvantages of the prior art. The particles or capsules of the invention protect the fragrance during its use and storage, protect it from interactions with other constituents from a base when used to fragrance a functional consumer product, and sustained release of the encapsulated fragrance from a substrate.

It is another object of the present invention to provide for fragrance delivery system comprising nano-particulate capsule based emulsion wherein the core material involves, a hydrophobic fragrance material and a process of manufacture thereof, that would on one hand protect and stabilize the fragrance material in the core and yet release the fragrance material over a period of time in a sustained manner.

It is yet another object of the present invention to provide for a delivery system preferably a fragrance delivery system that would protect the hydrophobic core material/fragrance from interactions with other constituents when employed in a formulation base to fragrance a functional consumer product, and yet favour its sustained release over time in said base.

It is still another object of the present invention, to provide for a process for manufacturing said delivery system that would be facile and economical to thus be advantageous to the industry.

### SUMMARY OF THE INVENTION

Is thus a basic aspect of the present invention to provide for Nano-particulate capsule comprising at least one or more of hydrophobic core material and a polymeric shell comprising homo-polymer or copolymers of at least one ethylenically unsaturated monomers or mixture thereof and having particle size distribution with an average particle size in the range of 50 to 1000 nm.

Preferably said nano-particulate capsule is provided wherein said hydrophobic core material and said shell material are selected to facilitate said nano-capsule formation involving hydrophobic core material in solution with polymeric shell forming material without being reactive to each other.

More preferably, said nano-particulate capsule comprises controlled fragrance releasing nano-particulate capsule wherein said hydrobhobic core material comprises hydrophobic fragrance material and said shell material facilitating controlled release of said fragrance material.

According to another preferred aspect of the present invention there is provided a nano-particulate capsules wherein said shell material is selected depending upon the desired cross-link density and thickness of the shell material based on the desired control release of hydrophobic core material content.

According to another aspect of the present invention there is provided a nano-particulate capsule water based emulsion comprising nano-particulate capsule having core material of at least one or more hydrophobic fragrance and a polymeric shell comprising homo-polymer or copolymers of at least one ethylenically unsaturated monomers or mixture thereof and having particle, size distribution with an average article size in the range of 50 to 1000 nm.

Preferably a nano-particulate capsule water based emulsion is provided wherein said nano-particulate capsule comprise polymerized monomers around surface of said core material containing fragrance droplet.

More preferably, a nano-particulate capsule water based emulsion is provided comprising a controlled release fragrance delivery system.

According to another preferred aspect of the present invention there is provided a nano-particulate capsule water based emulsion having stormer viscosity in the range of 40 to 120 g preferably 50 to 80 g.

According to yet another preferred aspect of the present invention there is provided said nano-particulate capsule water based emulsion wherein said polymeric shell involves a polymer composition comprising

at least one ethylenically unsaturated, monomer or mixture of ethylenically unsaturated monomers in the range of 5 to 50 wt %, preferably 10 to 35 wt %; and said core material comprise fragrance droplet of

at least one hydrophobic fragrance inside said polymeric shell in the range of 1 to 40 wt. %, more preferably 5 to 30 wt %. that is liquid at 25° C. which emanates a pleasant or otherwise desirable odour.

Preferably, said nano-particulate capsule water based emulsion comprises

(i) at least one ethylenically unsaturated monomer or mixtures thereof in the range of 5 to 50 wt. %, preferably 10 to 35 wt. %;

(ii) at least one fragrance that is liquid at 25° C. in the range of 1 to 40 wt %, preferably 5 to 30 wt. %;

(iii) at least one anionic or non-ionic surface active agents (or surfactants) or mixtures thereof in the range of 0.5 to 10 wt. %, preferably 1 to 5 wt. %;

(iv) at least one water soluble initiator or mixtures thereof in the range of 0.1 to 3 wt. %, preferably in the range of 0.3 to 1.5 wt. %;

and includes semi-continuous/seeded emulsion polymerised monomers around the surface of the fragrance droplet as said nano-capsules as template polymers with enhanced retention and reduced diffusion of fragrance molecules through the polymeric shell.

Preferably, said fragrance are odoriferous materials of relatively low boiling point, of less than 3000 C are liquid at room temperatures and are more soluble in organic phase than aqueous phase selected from chemicals including aldehydes, ketones, esters, alcohols, terpenes and the like also including naturally occurring plant and animal oils and extrudates comprising complex mixtures of various chemical components including woody/earthy bases containing exotic materials such as sandalwood oil, civet, patchouli oil, light floral fragrances including rose extract, Jasmine extract, violet extract also involving fruity odours of lime, lemon, orange and the like.

Preferably, said monomers are selected from the group consisting of olefins, ethylene, vinylaromatic monomers, esters of vinyl alcohol with mono- and di-carboxylic acids, esters of α, β-monoethylenically unsaturated mono- and dicarboxylic acids with alcohols, α, β-monoethylenically unsaturated monocarboxylic and dicarboxylic acids and their amides, methacrylic acid and its esters with alcohols and diols, acrylic acid and its esters with alcohols and diols or mixtures thereof and are preferably selected from: styrene; α-methylstyrene; o-chlorostyrene; vinyl acetate; vinyl propionate; vinyl n-butyrate; esters of acrylic, methacrylic acid with methyl, ethyl, n-butyl, isobutyl, n-hexyl and 2-ethylhexyl alcohol. The preferred monomers are styrene, methylmethacrylate and methacrylic acid.

According to another preferred aspect of the present invention there is provided a nano-particulate capsule water based emulsion wherein said monomers may optionally comprise monomers which are cross-linkers having at least two non-conjugated ethylenically unsaturated double bonds including alkylene glycol diacrylates and dimethacrylates, conjugated double bonds such as divinyl benzene from 0.1 to 10% by weight, based on the total amount of monomers to be polymerised.

According to yet another preferred aspect of the present invention there is provided said nano-particulate capsule water based emulsion comprising non-ionic emulsifiers, including ethoxylated linear fatty alcohols, of C12-C14 fatty. alcohols ethoxylated with ethylene oxide, ethylene oxide/propylene oxide block copolymers, selected from sorbitan stearate, polysorbate, and stearate, or mixtures thereof.

According to another preferred aspect of the present invention there is provided said nano-particulate capsule water based emulsion comprising anionic emulsifiers including disulfonated surfactant with tetrapropylene hydrophobe source, sodium dodecyl sulfate, ammoniumnonoxynol-sulfate, glyceryl stearate, or mixtures thereof.

Preferably said nano-particulate capsule water based emulsion comprises initiators for emulsion polymerization that are watersoluble initiators like peroxodisulfates, organic peroxides, hydroperoxides and water soluble azo-compounds selected from ammonium persulfate, sodium persulfate, potassium persulfate, 1,4-diisopropylbenzene hydroperoxide, cumene hydroperoxide, 2,2′-azobis(2-methylpropio-namidine)dihydrochlorid and 4,4′-azobis(4-cyanovaleric acid) preferably ammonium, potassium or sodium persulfates which allow thermic initiations.

According to yet another preferred aspect of the present invention there is provided a process for the preparation of said nano-particulate capsule water based emulsions comprising the steps of

(a) providing a solution of monomer of shell material in a liquid hydrophobic core material;

(b) dispersing the solution of step (a) into an emulsified aqueous phase under stirring to form pre-emulsion;

(c) subjecting a selective amount of pre-emulsion to controlled polymerization in emulsified aqueous phase for generating in-situ seeds followed by adding the remaining pre-emulsion facilitating polymerization of said monomers around the surface of droplets of said liquid core material content.

Preferably, in said process said hydrophobic core material and said shell material are selected to facilitate said nano-capsule formation involving hydrophobic core material in solution with polymeric shell forming material without being reactive to each other.

Preferably in said process said step (c) of involves subjecting the pre-emulsion in the range of 1 to 25 wt. %, preferably in the range of 2 to 10 wt. % to controlled polymerization for generating in-situ seeds followed by addition of remaining pre-emulsion.

More preferably in said process said step (c) for in-situ seed generation takes place in the temperature range of 50 to 90° C., preferably in the range of 65 to 85° C. under stirring followed by the addition of remaining pre-emulsion through peristaltic pump for polymerization in the temperature range of 60 to 90° C., preferably in the range of 65 to 85° C. over a period of 1 to 6 hours, preferably 2 to 5 hours.

According to yet another preferred aspect of the present invention there is provided said process wherein

said step (a) involves providing

(i) at least one ethylenically unsaturated monomer or mixtures thereof in the range of 5 to 50 wt. %, preferably 10 to 35 wt. %;

(ii) at least one hydrophobic core material including fragrance that is liquid at 25° C. in the range of 1 to 40 wt %, preferably 5 to 30 wt. %.

said step (b) involves dispersing the solution of step (a) in

(iii) at least one anionic or non-ionic surface active agents (or surfactants) or mixtures thereof taken in the range of 0.5 to 10 wt. %, preferably 1 to 5 wt. %;

(iv) at least one water soluble initiator or mixtures thereof in the range of 0.1 to 3 wt. %, preferably in the range of 0.3 to 1.5 wt. %.

According to another aspect of the present invention there is provided consumer product formulations including water based coating/paint formulations and industrial formulations comprising

nano-particulate capsule water based emulsion at levels of from 0.001% to 10%, preferably from 0.1% to 5% by weight of the total formulation having core material of at least one or more hydrophobic fragrance and a polymeric shell comprising homo-polymer or copolymers of at least one ethylenically unsaturated monomers or mixture thereof miscible but unreactive with said core fragrance material favouring nano-capsules with uniform core shell morphology and narrow particle size distribution with an average article size in the range of 50 to 1000 nm.

According to another preferred aspect of the present invention there is provided consumer product formulations comprising controlled fragrance releasing nano-particulate capsule based formulations wherein said hydrobhobic core material comprises hydrophobic fragrance material and said shell material facilitating controlled release of said fragrance material under ambient conditions.

A process of manufacturing nano-capsules is provided comprising a core containing a hydrophobic fragrance liquid and a polymeric shell using seeded emulsion polymerization. These core shell nano-capsule have narrow particle size distribution with an average particle size between 50 to 1000 nano meters.

The fragrances are liquids at 25° C. and are mixtures of many components. The fragrances are more soluble in organic phase than the aqueous phase.

The polymeric shell comprises a homo-polymer or a copolymer formed from ethylenically unsaturated monomers.

Also included in the present invention is a process of manufacturing a composition comprising particles which comprise a core material within a polymeric shell, wherein the core material comprises a hydrophobic fragrance, comprising the steps, 1) forming a solution of monomer in a fragrance liquid, 2) dispersing the monomer solution into an aqueous phase under stirring to form an emulsion, 3) subjecting the emulsion, 1 to 25 wt %, to polymerization for generating in-situ seeds followed by addition of remaining emulsion using peristaltic pump over a period of 2-5 hours at temperature range between 60 to 90° C. Under these conditions the core shell particles formation assumed to be the formation of polymer around the fragrance molecules. Such polymers are called template polymers which provide an enhanced retention of the fragrance molecules and reduced diffusion of fragrance molecules through the polymer.

The process described above yields nano-particles or capsules that perform better in their controlled release behaviour than fragranced nano-particles obtained by absorbing fragrance component into pre-formed nano-particles.

It is advantage that the seeded emulsion polymerization provides easy control on polymerization rate and particle size. Seeded emulsion polymerization also give less reactor build up, reduced pebble and give more stable lattices.

An additional advantage of the invention is that no need to use any homogenizer or sonicator for producing nano-capsule dispersions.

Further advantage is that the nano-particles formed are free from melamine formaldehyde condensates.

This invention also relates to paints and coatings compositions comprising emulsions containing encapsulated fragrances for improved fragrance delivery.

The present, invention is explained hereunder in greater details in relation to the non-limiting examples and figure.

### BRIEF DESCRIPTION OF FIGURES

FIG. 1. SEM images of Jasmine encapsulated polymer capsules (a)-original and (b)-measured.

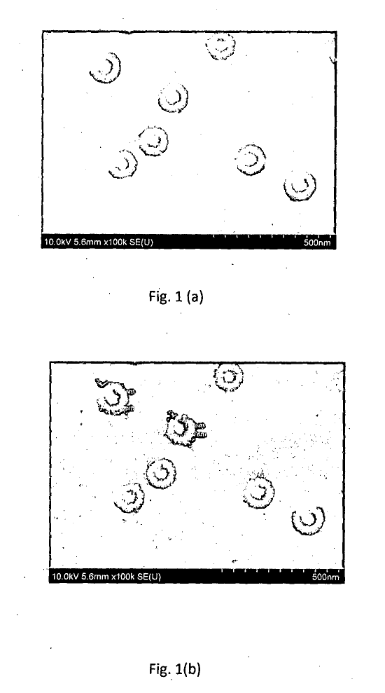

### DETAILED DESCRIPTION OF THE INVENTION

As discussed hereinbefore the present invention provides for nano-particulate capsule comprising at least one or more of hydrophobic core material and a polymeric shell comprising homo-polymer or copolymers of at least one ethylenically unsaturated monomers or mixture thereof and having particle size distribution with an average article size in the range of 50 to 1000 nm. A controlled release delivery system comprising a controlled fragrance release delivery system is provided comprising said nano-particulate capsule water based emulsion with a process of manufacture of said emulsion. Said delivery system is able to protect and release the fragrance in a controlled manner over a period of time. The controlled release fragrance delivery system of the present invention finds advantageous end use and application in fragranced consumer products formulations including water based coating/paint formulations and industrial formulations for use in industries including textile, cosmetics, soaps and detergents, leather industries.

In order to the present invention, further it is described in detail below with reference to preferred features.

The nano-capsules of the present invention comprise a core containing a hydrophobic fragrance liquid and a polymeric shell where the hydrophobic fragrances are liquids at 25° C. and are mixtures of many components.

Fragrances can be classified according to their volatility. The highly volatile, low boiling, fragrance ingredients typically have boiling points of about 2500 C or lower. The moderately volatile fragrance ingredients are those having boiling point of about 250-3000 C. The less volatile, high boiling, fragrance ingredients are those having boiling points of about 3000 C or higher. It is advantageous to encapsulate, those with a relatively low boiling point, preferably those with a boiling point of less than 3000 C.

Fragrances are typically composed of many components of different volatility. The present invention, avoiding separation of the components based on their different volatility, allows the sustained delivery of the full fragrance bouquet for a long time.

As used herein the term fragrance means any odoriferous material. In general, such materials are characterised by a vapour pressure less than atmospheric pressure at room temperature. The fragrances employed herein will most often be liquid at room temperatures and are more soluble in organic phase than aqueous phase. A wide variety of chemicals are used as fragrances, including materials such as aldehydes, ketones, esters, alcohols, terpenes and the like. Naturally occurring plant and animal oils and extrudates comprising complex mixtures of various chemical components are known for use as fragrances, and such materials can be used herein.

The fragrances herein can be relatively simple in their composition or can comprise highly sophisticated, complex mixtures of natural and synthetic chemical components, all chosen to provide any desired odour.

Typical fragrances which can be used in the present invention comprise, for example, woody/earthy bases containing exotic materials such as sandalwood oil, civet, patchouli oil and the like. Other suitable fragrances are for example light, floral fragrances, e.g., rose extract, Jasmine extract, violet extract and the like. Fragrances can be formulated to provide desirable fruity odours, e.g., lime, lemon, orange and the like.

In short, any chemically compatible material which emanates a pleasant or otherwise desirable odour can be used as a fragrance in the present invention.

The amount of the active ingredient suitable for encapsulation mainly depends on the desirable effect of the end product. For example, if the active ingredient is a fragrance, an amount up to 20% by weight, based on the emulsion, is suitable.

The polymer particles of .the invention can comprise a wide selection of monomeric units. By monomer units as used herein is meant the monomeric units of the polymer chain.

Monomers for free radical polymerization:

Suitable classes of such monomers are given in the group consisting of olefins, ethylene, vinylaromatic monomers, esters of vinyl alcohol with mono- and di-carboxylic acids, esters of α, β-monoethylenically unsaturated mono- and dicarboxylic acids with alcohols, α, β-monoethylenically unsaturated monocarboxylic and dicarboxylic acids and their amides, methacrylic acid and its esters with alcohols and diols, acrylic acid and its esters with alcohols and diols. The polymer particle may comprise mixtures of monomer units.

The monomers are preferably selected from: styrene; α-methylstyrene; o-chlorostyrene; vinyl acetate; vinyl propionate; vinyl n-butyrate; esters of acrylic, methacrylic acid with methyl, ethyl, n-butyl, isobutyl, n-hexyl and 2-ethylhexyl alcohol. The preferred monomers are styrene, methylmethacrylate and methacrylic acid.

The polymer particle may optionally comprise monomers which are cross-linkers. Such cross-linkers may have at least two non-conjugated ethylenically unsaturated double bonds. Examples are alkylene glycol diacrylates and dimethacrylates. Further types of suitable cross-linking monomers are those that are conjugated, such as divinyl benzene. If present, these monomers constitute from 0.1 to 10% by weight, based on the total amount of monomers to be polymerised.

Optional cross-linkers include vinyltoluenes, divinyl benzene, ethylene glycol diacrylate, 1,2-propylene glycol diacrylate, 1,3-propylene glycol diacrylate, 1,3-butylene glycol diacrylate, 1,4-butylene glycol diacrylates, ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, divinylbenzene, vinyl methacrylate, vinyl acrylate, allyl methacrylate, allyl acrylate.

The choice of a suitable emulsifier is less critical in the polymerization process of the present invention. Anionic, cationic and non-ionic emulsifiers are suitable, however anionic and non-ionic emulsifiers are preferred.

The following list comprises examples of emulsifiers suitable for the preparation of polymer particles according to the present invention:

Non-ionic emulsifiers, e.g. ethoxylated linear fatty alcohols, such as C12-C14 fatty alcohols ethoxylated with ethylene oxide, ethylene oxide/propylene oxide block copolymers, e.g. available from Uniqema under the trade name Synperonic™, sorbitan stearate, polysorbate, and stearate, or mixtures thereof, e.g. available from Croda under the trade name of Tween.

Anionic emulsifiers, e.g. disulfonated surfactant with tetrapropylene hydrophobe source available from DOW under the trade name of Dowfax 2A1, odium dodecyl sulfate, ammoniunnnonoxynol-sulfate, e.g. available from Rhodia under the trade name Abex EP-227, and glyceryl stearate, or mixtures thereof.

Initiators useful for emulsion polymerization are watersoluble initiators like peroxodisulfates, organic peroxides, hydroperoxides and water soluble azo-compounds. Specific examples of suitable initiators are ammonium persulfate, sodium persulfate, potassium persulfate, 1,4-diisopropylbenzene hydroperoxide, cumene hydroperoxide, 2,2′-azobis(2-methylpropionamidine)dihydrochlorid and 4,4′-azobis(4-cyanovaleric acid).

Preferred are the ammonium, potassium or sodium persulfates which allow thermic initiations.

In general, the polymerization is performed by admixing the monomer, the active ingredient, emulsifier and water at room temperature or elevated temperature to obtain an emulsion, followed by initiation of the polymerization reaction by addition of initiator catalyst. The polymerization reaction is preferably performed under elevated temperature up to about 900 C or lower. Depending on the reactivity of the monomer and the catalyst, it may take between a few hours, e.g. two to five hours, up to several days until the polymerization reaction is completed. Whether the polymerization process is completed or not may be analysed by measuring the monomer concentration by methods known to the persons skilled in the art. The polymerization reaction is completed when the monomer concentration of the aqueous phase is stable over a longer period.

Accordingly, the present invention relates in a further aspect to a method of preparing polymer particles comprising the steps of 1) forming a solution of monomer in a fragrance liquid, 2) dispersing the monomer solution into an aqueous phase under stirring to form an emulsion, 3) subjecting the emulsion, 1 to 25 wt %, to polymerization for generating in-situ seeds followed by addition of remaining emulsion using peristaltic pump over a period of 2-5 hours at temperature range between 60 to 90° C. Under these conditions the core shell particles formation assumed to be the formation of polymer around the fragrance molecules.

The final latex particle size in emulsion polymerization is controlled by the short nucleation stage at the start of the reaction and by the stabilisation of nuclei during the growth stage. Nucleation depends on the formation of radicals, a process that is very variable. This variability leads to variations in polymerization rate and in the size of the final latex particle. The addition of seed particles at the start of the reaction, removes the variability in the nucleation step. Polymerisation rate and particle size can be easily controlled. Seeded emulsion polymerization also give less reactor build up, reduced pebble and give more stable latices.

The polymer particles of the invention may be incorporated in paint or coating compositions. This may be done by mixing the capsules dispersion with some or all of the other components of the paint or coating composition. The nano-capsule dispersions are typically included in said compositions at levels of from 0.001% to 10%, preferably from 0.005% to 5% by weight of the total composition.

### EXAMPLES

### Example 1

### Pre-Emulsion Preparation

An oil phase was prepared by mixing 80 g of Rose Breeze with 120 g of methylmethacrylate. An aqueous phase was prepared by mixing 233g of demineralised water, 6.75 g of Tween 20, 2.25 g of Dow Fax and 0.5 g of sodium bicarbonate. The prepared oil phase was slowly added to aqueous phase under stirring with anchor stirrer at room temperature for about 15 minutes. To get stable oil in water emulsion, stirring continued for about 30 minutes.

In-Situ Seed Generation and Polymerisation

A 1 liter reaction flask equipped with a stirrer, reflux condenser, thermometer and inlet tube for delivery from a peristaltic pump is placed in a water batch. The seed materials 55 g of demineralised water, 0.75 g of Tween 20, and 0.25 g of Dow fax were charged in to the reaction flask and then the content of the reaction flask was heated to 80° C. At this temperature 0.2 g of potassium persulfate and 5% of the above prepared pre-emulsion was charged and allowed to polymerise. After 10 minutes the remaining pre-emulsion was added dropwise in to the reaction flask under stirring at 150 rpm, using a peristaltic pump over a period of 180 minutes. After terminating the addition, the reaction mixture is stirred for further 60 more minutes before the reaction mixture is cooled to room temperature. The resulting nano-capsules had a solid content of 40% and an average particle size of 150 nm.

### Example 2

Example 1 was repeated with an oil phase of 120 g of methylmethacrylate and 80 g of Jasmine oil. In example 1 the Tween 20 was replaced with Tween 80. The prepared nano-capsules dispersion had a solid content of 40% and average particle size of 175 nm.

### Example 3

Example 1 was repeated with an oil phase of 29 g of methylmethacrylate, 8 g of methacrylic acid, 85 g of styrene, 1.25 g of ethyleneglycol dimethacrylate and 80 g of Jasmine mist oil. In example 1 the Tween 20 was replaced with Tween 80. The prepared nano-capsules dispersion had a solid content of 40% and average particle size of 132 nm.

The nano-particulate capsules water based dispersions thus obtained when added to consumer product formulations including water based coating/paint formulations and industrial formulations at levels of from 0.001% to 10%, more preferably only from 0.1% to 5% by weight of the total composition releases fragrance over a period of at least 6 months times under room temperature and pressure conditions whereas under identical conditions if fragrance is directly added (without encapsulation) to paint or coating its release period is only 7 days. Nano-particulate capsule based paints of the present invention when coated in the interior of rooms and continued exude fragrance for at least 6 months.

It is thus possible by way of the present advancement to provide for nano-particulate capsule and its water based emulsion thereof comprising at least one or more of hydrophobic core material and a polymeric shell comprising homo-polymer or copolymers of at least one ethylenically unsaturated monomers or mixture thereof and having particle size distribution with an average article size in the range of 50 to 1000 nm. Advantageously a controlled release delivery system including fragrance release delivery system comprising said nano-particulate capsule water based emulsion is also provided wherein the core material involves a hydrophobic fragrance material together with a process of manufacture said emulsion. Said delivery system is able to protect and release the fragrance in a controlled and sustained manner over a period of time. The controlled release fragrance delivery system of the present invention advantageously finds end use and application in fragranced consumer products formulations including water based coating/paint formulations and industrial formulations for use in industries including textile, cosmetics, soaps and detergents, leather industries.

We claim:

1. Nano-particulate capsule comprising at least one or more of hydrophobic core material and a polymeric shell comprising homo-polymer or copolymers of at least one ethylenically unsaturated monomers or mixture thereof and having particle size distribution with an average particle size in the range of 50 to 1000 nm.

2. Nano-particulate capsule according to claim 1 wherein said hydrophobic core material and said shell material are selected to facilitate said nano-capsule formation involving hydrophobic core material in solution with polymeric shell forming material without being reactive to each other.

3. Nano-particulate capsule according to claim 1 comprising controlled fragrance releasing nano-particulate capsule wherein said hydrobhobic core material comprises hydrophobic fragrance material and said shell material facilitating controlled release of said fragrance material.

4. Nano-particulate capsule according to claim 1 wherein said shell material is selected depending upon the desired cross-link density and thickness of the shell material based on the desired control release of hydrophobic core material content.

5. Nano-particulate capsule water based emulsion comprising nano-particulate capsule having core material of at least one or more hydrophobic fragrance and a polymeric shell comprising homopolymer or copolymers of at least one ethylenically unsaturated monomers or mixture thereof and having particle size distribution with an average article size in the range of 50 to 1000 nm.

6. Nano-particulate capsule water based emulsion according to claim 5 wherein said nano-particulate capsule comprise water based emulsion polymerized monomers around surface of said core material containing fragrance droplet.

7. Nano-particulate capsule water based emulsion according to claim 5 comprising a controlled release fragrance delivery system.

8. Nano-particulate capsule water based emulsion according to claim 5 having stormer viscosity in the range of 40 to 120 g preferably to 80 g.

9. Nano-particulate capsule water based emulsion according to claim 5 wherein said polymeric shell involves a polymer composition comprising at least one ethylenically unsaturated monomer or mixture of ethylenically unsaturated monomers in the range of 5 to 50 wt %, preferably 10 to 35 wt %; and said core material comprise fragrance droplet of
at least one hydrophobic fragrance inside said. polymeric shell in the range of 1 to 40 wt. %, more preferably 5 to 30 wt %. that is liquid at 25° C. which emanates a pleasant or otherwise desirable odour.

10. Nano-particulate capsule water based emulsion according to claim 5 comprising
(i) at least one ethylenically unsaturated monomer or mixtures thereof in the range of 5 to 50 wt. %, preferably 10 to 35 wt. %;
(ii) at least one fragrance that is liquid at 25° C. in range of 1 to 40 wt %, preferably 5 to 30 wt. %;
(iii) at least one anionic or non-ionic surface active agents (or surfactants) or mixtures thereof in the range of 0.5 to 10 wt. %, preferably 1 to 5 wt. %;
(iv) at least one water soluble initiator or mixtures thereof in the range of 0.1 to 3 wt. %, preferably in the range of 0.3 to 1.5 wt. %;
and includes semi-continuous/seeded emulsion polymerised monomers around the surface of the fragrance droplet as said nano-capsules as template polymers with enhanced retention and reduced diffusion of fragrance molecules through the polymeric shell.

11. Nano-particulate capsule water based emulsion according to claim 5 wherein said fragrance are odoriferous materials of relatively low boiling point, of less than 3000 C are liquid at room temperatures and are more soluble in organic phase than aqueous phase selected from chemicals including aldehydes, ketones, esters, alcohols, terpenes and the like also including naturally occurring plant and animal oils and extrudates comprising complex mixtures of various chemical components including woody/earthy bases containing exotic materials such as sandalwood oil, civet, patchouli oil, light floral fragrances including rose extract, Jasmine extract, violet extract also involving fruity odours of lime, lemon, orange and the like.

12. Nano-particulate capsule water based emulsion according to claim 5 wherein said monomers are selected from the group consisting of olefins, ethylene, vinylaromatic monomers, esters of vinyl alcohol with mono- and di-carboxylic acids, esters of α, β-monoethylenically unsaturated mono- and dicarboxylic acids with alcohols, α, β-monoethylenically unsaturated monocarboxylic and dicarboxylic acids and their amides, methacrylic acid and its esters with alcohols and diols, acrylic acid and its esters with alcohols and diols or mixtures thereof and are preferably selected from: styrene; α-methylstyrene; o-chlorostyrene; vinyl acetate; vinyl propionate; vinyl n-butyrate; esters of acrylic, methacrylic acid with methyl, ethyl, n-butyl, isobutyl, n-hexyl and 2-ethylhexyl alcohol and preferable monomers are styrene, methylmethacrylate and methacrylic acid.

13. Nano-particulate capsule water based emulsion according to claim 12 wherein said monomers may optionally comprise monomers which are cross-linkers having at least two non-conjugated ethylenically unsaturated double bonds including alkylene glycol diacrylates and dimethacrylates, conjugated double bonds such as divinyl benzene from 0.1 to 10% by weight, based on the total amount of monomers to be polymerised.

14. Nano-particulate capsule water based emulsion according to claim 5 comprising non-ionic emulsifiers, including ethoxylated linear fatty alcohols, of C12-C14 fatty alcohols ethoxylated with ethylene oxide, ethylene oxide/propylene oxide block copolymers, selected from sorbitan stearate, polysorbate, and stearate, or mixtures thereof.

15. Nano-particulate capsule water based emulsion according to claim 5 comprising anionic emulsifiers including disulfonated surfactant with tetrapropylene hydrophobe source, sodium dodecyl sulfate, ammoniumnonoxynol-sulfate, glyceryl stearate, or mixtures thereof.

16. Nano-particulate capsule water based emulsion according to claim 5 comprising initiators for emulsion polymerization that are water soluble initiators like peroxodisulfates, organic peroxides, hydroperoxides and water soluble azo-compounds selected from ammonium persulfate, sodium persulfate, potassium persulfate, 1,4-diisopropylbenzene hydroperoxide, cumene hydroperoxide, 2,2′-azobis(2-methylpropio-namidine)dihydrochlorid and 4,4′-azobis(4-cyanovaleric acid) preferably ammonium, potassium or sodium persulfates which allow thermic initiations.

17. A process for the preparation of nano-particulate capsule water based emulsion of claim 5 comprising the steps of
(a) providing a solution of monomer of shell material in a liquid hydrophobic core material;
(b) dispersing the solution of step (a) into an emulsified aqueous phase under stirring to form pre-emulsion;
(c) subjecting a selective amount of pre-emulsion to controlled polymerization in emulsified aqueous phase for generating in-situ seeds followed by adding the remaining pre-emulsion facilitating polymerization of said monomers around the surface of droplets of said liquid core material content.

18. A process according to claim 17 wherein said hydrophobic core material and said shell material are selected to facilitate said nano-capsule formation involving hydrophobic core material in solution with polymeric shell forming material without being reactive to each other.

19. A process for the preparation of nano-particulate capsule water based emulsion according to claim 17 wherein said step (c) of involves subjecting the pre-emulsion in the range of 1 to 25 wt. %, preferably in the range of 2 to 10 wt. % to controlled polymerization for generating in-situ seeds followed by addition of remaining pre-emulsion.

20. A process according to claim 17 wherein
said step (c) for in-situ seed generation takes place in the temperature range of 50 to 90° C., preferably in the range of 65 to 85° C. under stirring followed by the addition of remaining pre-emulsion through peristaltic pump for polymerization in the temperature range of 60 to 90° C., preferably in the range of 65 to 85° C. over a period of 1 to 6 hours, preferably 2 to 5 hours.

21. A process according to claim 17 wherein
said step (a) involves providing
(i) at least one ethylenically unsaturated monomer or mixtures thereof in the range of 5 to 50 wt. %, preferably 10 to 35 wt. %;
(ii) at least one hydrophobic core material including fragrance that is liquid at 25° C. in the range of 1 to 40 wt %, preferably 5 to 30 wt. %.
said step (b) involves dispersing the solution of step (a) in
(iii) at least one anionic or non-ionic surface active agents (or surfactants) or mixtures thereof taken in the range of 0.5 to 10 wt. %, preferably 1 to 5 wt. %;
(iv) at least one water soluble initiator or mixtures thereof in the range of 0.1 to 3 wt. %, preferably in the range of 0.3 to 1.5 wt. %.

22. Consumer product formulations including water based coating/paint formulations and industrial formulations comprising
nano-particulate capsule water based emulsion at levels of from 0.001% to 10%, preferably from 0.1% to 5% by weight of the total formulation having core material of at least one or more hydrophobic fragrance and a polymeric shell comprising homo-polymer or copolymers of at least one ethylenically unsaturated monomers or mixture thereof miscible but unreactive with said core fragrance material favouring nano-particulate capsules with uniform core shell morphology and narrow particle size distribution with an average article size in the range of 50 to 1000 nm.

23. Consumer product formulations according to claim 22 comprising controlled fragrance releasing nano-particulate capsule based formulations wherein said hydrobhobic core material comprises hydrophobic fragrance material and said material facilitating controlled release of said fragrance material under ambient conditions.

24. Nano-particulate capsule according claim 1 comprising in-situ polymerizaton encapsulating said hydrophobic core material in said polymeric shell.

25. Nano-particulate capsule water based emulsion according to claim 5 comprising in-situ polymerization enapsulating said hydrophobic core material in said polymeric shell.
